(19) United States
(12) Patent Application Publication
(10) Pub. No.: US 2024/0249207 A1
(43) Pub. Date: Jul. 25, 2024

(54) PARKING RESERVATION MANAGEMENT DEVICE

(71) Applicant: TOYOTA JIDOSHA KABUSHIKI KAISHA, Aichi-ken (JP)

(72) Inventors: Takuji MATSUBARA, Aichi-ken (JP); Osamu YUMITA, Aichi-ken (JP); Naoki HASEGAWA, Aichi-ken (JP); Sa KANO, Aichi-ken (JP)

(21) Appl. No.: 18/414,464

(22) Filed: Jan. 17, 2024

(30) Foreign Application Priority Data
Jan. 20, 2023 (JP) 2023-007299

(51) Int. Cl. G06Q 10/02; B60L 53/30; B60L 53/60

(52) U.S. Cl. CPC G06Q 10/02; B60L 53/30; B60L 53/60

(57) ABSTRACT

The parking reservation management device manages a parking lot having a chargeable parking space to which a charging device for charging a battery installed in a vehicle is attached and a chargeable and dischargeable parking space to which a charging and discharging device for charging and discharging the battery is attached. The parking reservation management device performs, when making a parking reservation, a confirmation process to confirm that the vehicle to be parked is chargeable and dischargeable of the battery by the charging and discharging device, and to confirm that the charging and discharging device may charge and discharge the battery while the vehicle is parked, and the parking reservation management device assigns a chargeable and dischargeable parking space preferentially to the vehicle that has been confirmed by the aforementioned confirmation process.

### CROSS-REFERENCE TO RELATED APPLICATION

The present disclosure claims priority to Japanese Patent Application No. 2023-007299 filed on Jan. 20, 2023, which is incorporated herein by reference in its entirety including specification, drawings and claims.

### TECHNICAL FIELD

The present disclosure relates to a parking reservation management device, and in particular, to a parking reservation management device for a parking lot having a chargeable and dischargeable parking space to which a charging and discharging device for charging and discharging a battery installed in a vehicle is attached.

### BACKGROUND

Conventionally, a system with a storage battery installed in a parking lot, an AC power converter for this storage battery, and a charging and discharging stand for electric vehicles has been proposed that can also supply power to a load from the charging and discharging stand or the AC power converter (for example, refer to Patent Document 1). In this system, power is supplied to the load from a charging and discharging stand or an AC power converter, so that power can be supplied to the load even in the event of a failure of the commercial power system.

### CITATION LIST

### Patent Literature

PTL 1: JP2020-010442

### SUMMARY

In a parking lot that has a chargeable parking space equipped with a charging device that can only charge the battery installed in the vehicle and a chargeable and dischargeable parking space equipped with a charging and discharging device that can charge and discharge the battery installed in the vehicle, determining which vehicle should be parked in which parking space is an extremely important issue.

The parking reservation management device of the present disclosure has the main objective of assigning more appropriate vehicle to park in a chargeable and dischargeable parking space.

The parking reservation management device of the present disclosure has adopted the following means to achieve the main objectives described above.

The parking reservation management device of this disclosure is a parking reservation management device for a parking lot that can communicate via a communication network, having a chargeable parking space to which a charging device for charging a battery installed in a vehicle is attached and a chargeable and dischargeable parking space to which a charging and discharging device for charging and discharging the battery is attached, and capable of exchanging electric power between the parking lot and a predetermined facility, the parking reservation management device is characterized by: the parking reservation management device performs, when making a parking reservation, a confirmation process to confirm that the vehicle to be parked is chargeable and dischargeable of the battery by the charging and discharging device, and to confirm that the charging and discharging device may charge and discharge the battery while the vehicle is parked, and the parking reservation management device assigns a chargeable and dischargeable parking space preferentially to the vehicle that has been confirmed by the confirmation process.

The parking reservation management device of the present disclosure accepts parking reservations fora parking lot that has a chargeable parking space to which a charging device for charging a battery installed in a vehicle is attached and a chargeable and dischargeable parking space to which a charging and discharging device for charging and discharging the battery is attached. The parking reservation management device performs, when making a parking reservation, a confirmation process to confirm that the vehicle to be parked is chargeable and dischargeable of the battery by the charging and discharging device, and to confirm that the charging and discharging device may charge and discharge the battery while the vehicle is parked, and the parking reservation management device assigns a chargeable and dischargeable parking space preferentially to the vehicle that has been confirmed by the aforementioned confirmation process. This allows for more effective exchange of power to and from the predetermined facility. As a result, more appropriate vehicle can be assigned to park in the chargeable and dischargeable parking space.

### BRIEF DESCRIPTION OF DRAWINGS

FIG. 1 shows a schematic configuration of the parking reservation system 10 including the parking reservation management device 20 as an embodiment of the present disclosure.

FIG. 2 shows a schematic configuration of the electric vehicle 120 that can use the chargeable and dischargeable parking space 36 of the parking lot 30.

FIG. 3 shows a flowchart of an example of the parking reservation process executed by the parking reservation management unit 24 and the parking application 230.

FIG. 4 shows a flowchart of a modified parking reservation process.

FIG. 5 shows a flowchart of an example of the reservation cancellation process executed by the parking reservation management unit 24 and the parking application 230.

### DESCRIPTION OF EMBODIMENTS

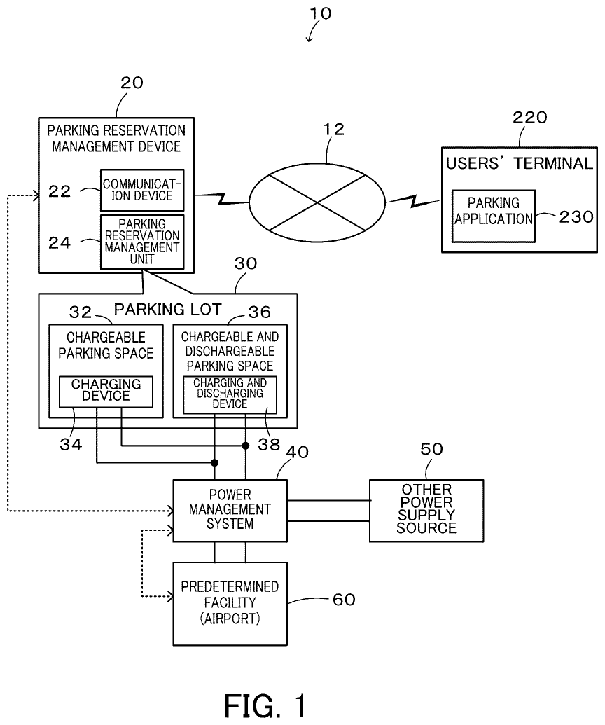

Next, the embodiment of this disclosure will be described. FIG. 1 shows a schematic configuration of the parking reservation system 10 including the parking reservation management device 20 as an embodiment of the present disclosure. The parking reservation system 10 has the communication network (wired or wireless) 12, the parking reservation management device 20 connected to the communication network 12, and the users' terminal 220 connected to the communication network 12.

The parking reservation management device 20 accepts parking reservations for parking spaces in the parking lot 30 attached to the predetermined facility (e.g., airport) 60. The parking reservation management device 20 is composed of a microcomputer, for example. The parking reservation management device 20 has a communication device 22 for communicating with the communication network 12 and the parking reservation management unit 24 that accepts and manages parking reservations. The parking reservation management unit 24 is a functional block that functions as a combination of hardware and application software.

The parking lot 30 has a plurality of the chargeable parking space 32 with the charging device 34 that can only charge the battery installed in the vehicle, a plurality of the chargeable and dischargeable parking space 36 with the charging and discharging device 38 that can chargeable and discharge the battery installed in the vehicle, and a plurality of the general parking spaces (not shown) where the charging device 34 or charging and discharging device 38 is not installed. Each parking space is assigned parking space information including identification number, type, and location. The parking space information is stored in the parking reservation management unit 24 of the parking reservation management device 20.

Each of the charging device 34 installed in a plurality of the chargeable parking space 32 is connected by a power line to the other power supply source 50 via the power management system 40. Each charging device 34 charges the battery on the vehicle parked in the chargeable parking space 32 using power from the other power supply source 50. Each of the charging and discharging device 38 installed in a plurality of the chargeable and dischargeable parking space 36 is connected by power lines to the other power supply source 50 or to the predetermined facility 60 via the power management system 40. Each of the charging and discharging device 38 charges the battery on the vehicle parked in chargeable and dischargeable parking space 36 using power supplied from the other power supply source 50, or supplies power from the battery to the predetermined facility 60.

The power management system 40 manages the charging of batteries mounted on parked vehicles by supplying power from the other power supply source 50 to the charging device 34 in the chargeable parking space 32 and the charging and discharging device 38 in the chargeable and dischargeable parking space 36. The power management system 40 manages the supply of power from the other power supply source 50 to the predetermined facility 60. The power management system 40 manages the supply of power from the charging and discharging device 38 in the chargeable and dischargeable parking space 36 to the predetermined facility 60.

The other power supply source 50 are envisioned to include, for example, at least some of the following: the commercial power supply, the solar power supply, the wind power supply, the tidal power supply, and the geothermal power supply.

The users' terminal 220 is configured, for example, as a portable communication terminal. The users' terminal 220 has the parking application 230 installed, which can be used with the parking reservation system 10.

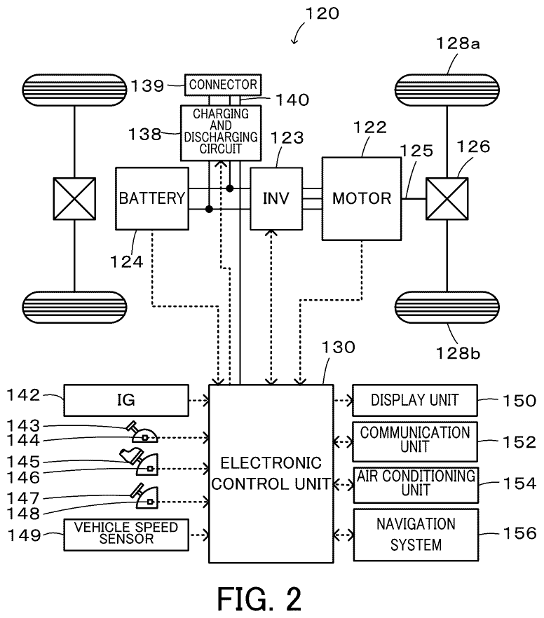

The vehicle that can use the chargeable and dischargeable parking space 36 in the parking lot 30 can be, for example, the electric vehicle 120 illustrated in FIG. 2. The electric vehicle 120 is equipped with the motor 122, the inverter 123, the battery 124, the charging and discharging circuit 138, the connector 139, and the electronic control unit 130.

The motor 122 is configured, for example, as the synchronous generator motor. The rotor of the motor 122 is connected to the drive shaft 125 connected to the drive wheels 128a, 128b via the differential gear 126. The motor 122 is driven by three-phase AC power applied by the inverter 123 after DC power from the battery 124 is converted to three-phase AC power by the inverter 123. The battery 124 is configured as a well-known lithium-ion rechargeable battery or nickel-metal hydride rechargeable battery.

The charging and discharging circuit 138 is connected at one end to a power line connected to the battery 124 and at the other end to the connector 139 for connection to the charging and discharging device 38. The charging and discharging circuit 138 has the charging and discharging relay, which is not shown in the figure. The charging and discharging circuit 138 is connected to and disconnected from the battery 124 by the charging and discharging relay.

The electronic control unit 130 is configured as a microcomputer, which is mainly composed of a CPU, not shown in the figure. The electronic control unit 130 receives signals from various sensors via input ports. For example, the electronic control unit 130 inputs the ignition signal from the ignition switch 142, the shift position SP from the shift position sensor 144 that detects the position of the shift lever 143, the acceleration Acc from the accelerator pedal position sensor 146 that detects the amount of depressing the accelerator pedal 145, the brake position BP from the brake pedal position sensor 148 that detects the amount of depressing the brake pedal 147, and the vehicle speed V from the vehicle speed sensor 149. The electronic control unit 130 also inputs the rotation position θ from the rotation position sensor (not shown) that detects the rotation position of the motor 122, the battery voltage Vb from the voltage sensor (not shown) attached to the output terminal of the battery 124, the battery current Ib from the current sensor (not shown) attached to the output terminal of the battery 124, the charging and discharging voltage Vchg from the voltage sensor attached to the charging and discharging circuit 138, and the charging and discharging current Ichg from the current sensor attached to the charging and discharging circuit 138.

The electronic control unit 130 outputs various control signals via output ports. For example, the electronic control unit 130 outputs the display control signals to the display unit 150, the communication control signals to the communication unit 152, and the air conditioning control signals to the air conditioning unit 154. The electronic control unit 130 also outputs the switching control signals for switching the switching elements (not shown) to the inverter 123 to drive the motor 122, the drive control signals to the system main relay (not shown) mounted near the battery 124, and the drive control signal to the charging and discharging relay (not shown) attached to the charging and discharging circuit 138. The electronic control unit 130 communicates with the navigation system 156, which displays various information and provides route guidance. The signal line 140 is connected to the electronic control unit 130 to communicate with the charging and discharging device 38 when the charging and discharging device 38 is connected via the connector 139.

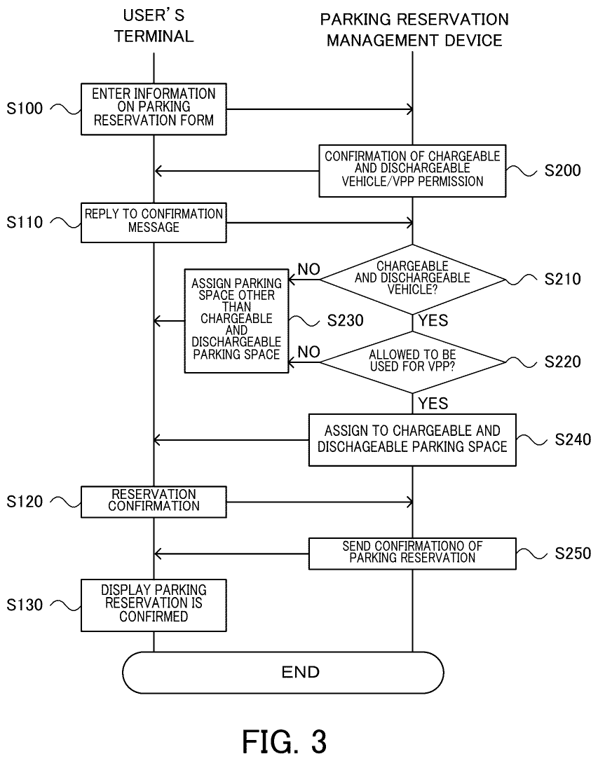

Next, the operation of the parking reservation system 10 of the embodiment, especially the operation when making a parking reservation, will be described. FIG. 3 shows a flowchart of an example of the parking reservation process executed by the parking reservation management unit 24 of the parking reservation management device 20 and the parking application 230 of the users' terminal 220.

The parking reservation process begins by entering the required information on the parking reservation form from the users' terminal 220 and transmitting it to the parking reservation management device 20 (step S100). The parking reservation form is activated by using the parking application 230 installed on the users' terminal 220. Items to be entered in the parking reservation form include, for example, the user's name, user's address, the scheduled entry date and time to the parking lot, the scheduled exit date and time from the parking lot, the type of the vehicle, whether or not the vehicle's onboard battery can be charged and discharged, whether or not the onboard battery needs to be charged before the vehicle leaves, whether or not the vehicle's onboard battery can be used as a VPP (Virtual Power Plant) during parking, etc. If the parking lot is attached to an airport, instead of the scheduled entry date and time to the parking lot and the scheduled exit date and time from the parking lot, the flight schedule information may be obtained by entering the flight ticket identification number, for example. At this time, the scheduled entry date and time to the parking lot and the scheduled exit date and time from the parking lot may be estimated backward from the flight schedule information and entered into the parking reservation management device.

The parking reservation management device 20 confirms the vehicle is a chargable and dischargeable vehicle that can be used for VPP for those users whose parking reservation form entry from the users' terminal 220 permits them to use the vehicle for VPP and the parking reservation for the vehicle that allows charging and discharging of the on-board battery. The parking reservation management device 20 also sends a control signal to the users' terminal 220 to display a confirmation of permission to use the VPP (step S200). The confirmation should read, for example, “This vehicle is available for use in a Virtual Power Plant (VPP). Please confirm permission for use in a VPP.” or something like that. In response to the confirmation message, the user replies with a “yes” or “no” response from the users' terminal 220 (step S110).

The parking reservation management device 20 determines whether the confirmation reply from the users' terminal 220 confirms that the vehicle is a chargeable and dischargeable vehicle that can be used for the VPP (step S210). The parking reservation management device 20 also determines whether or not it has confirmed that the battery of the parked vehicle is allowed to be used for VPP (step S220). The parking reservation management device 20 assigns a parking space other than the chargeable and dischargeable parking space 36 (the chargeable parking space 32 or the general parking space) to the vehicle for the parking reservation when it is determined that confirmation has not been obtained for either one of them. The parking reservation management device 20 then sends the control signal to display information such as the identification number and location of the assigned parking space in addition to the items entered in the parking reservation form on the users' terminal 220 (step S230). On the other hand, when it is determined that confirmation for both in steps S210 and S220 has been obtained, the parking reservation management device 20 assigns the vehicle for the parking reservation to the chargeable and dischargeable parking space 36 and sends a control signal to the users' terminal 220 to display the assigned parking space identification number, location in addition to the items entered on the parking reservation form (step S240).

The user sends confirmation to the display on the users' terminal 220 (step S120). Upon receiving the confirmation, the parking reservation management device 20 sends a control signal indicating that the parking reservation has been confirmed (step and ends the parking reservation process as the parking reservation management device 20. On the other hand, the users' terminal 220 displays the fact that the parking reservation from the parking reservation management device 20 has been confirmed (step S130), and ends the parking reservation process as the users' terminal 220.

The parking reservation management device 20 in the embodiment described above performs, when making a parking reservation, a confirmation process to confirm that the vehicle to be parked is chargeable and dischargeable of the battery by the charging and discharging device 38, and to confirm that the charging and discharging device 38 may charge and discharge the battery while the vehicle is parked, and the parking reservation management device 20 assigns the chargeable and dischargeable parking space 36 preferentially to the vehicle that has been confirmed by the aforementioned confirmation process. This allows for more effective exchange of power to and from the predetermined facility 60. As a result, the parking reservation management device 20 can assign more appropriate vehicle to the chargeable and dischargeable parking space 36.

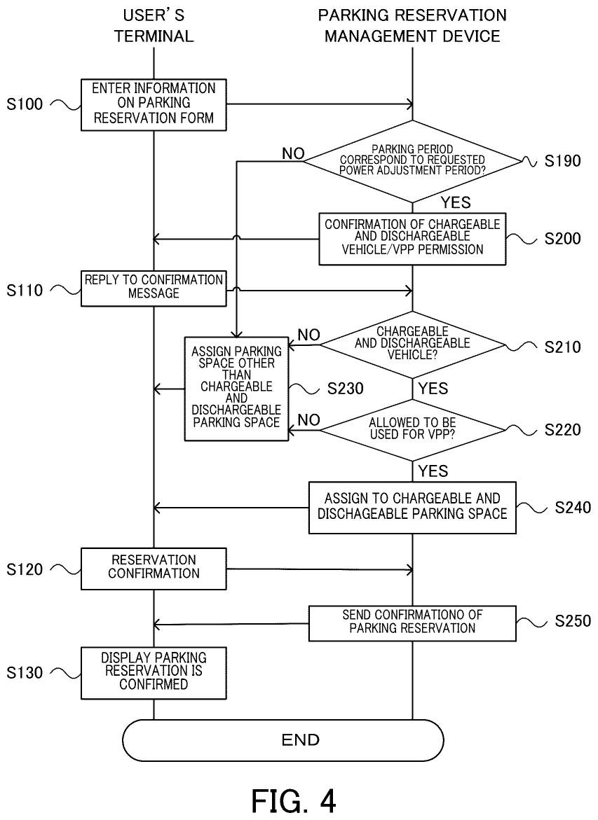

The parking reservation management device 20 of the embodiment inputs on the parking reservation form whether the vehicle is chargeable and dischargeable to the battery installed in the vehicle and whether the battery installed in the vehicle is allowed to be used as a VPP while parked, and the parking reservation management device 20 uses the confirmation process to confirm that the vehicle is chargeable and dischargeable for use in the VPP and to confirm permission for use in the VPP. However, The parking reservation management device 20 may not make whether the vehicle is chargeable and dischargeable to the battery installed in the vehicle and whether the battery installed in the vehicle is allowed to be used as a VPP during parking as input items in the parking reservation form, and the parking reservation t device 20 may use the confirmation process to confirm that the vehicle is chargeable and dischargeable for use to the VPP and to confirm permission for use to the VPP. In this case, as shown in the parking reservation process illustrated in FIG. 4, the parking reservation management device 20 may determine whether or not to perform the confirmation process based on whether or not the parking period based on the scheduled entry date and time and the scheduled exit date and time matches the requested power adjustment period for the predetermined facility 60. The requested power adjustment period for a predetermined facility 60 is a period of time determined by the power management system 40 as being necessary to charge and discharge the batteries installed in the vehicles parked in the chargeable and dischargeable parking space 36. This period is based on the power demand of the predetermined facility 60. This period is determined by taking into account the times and times when the power supplied by the other power supply source 50 cannot provide the power needed for the predetermined facility 60, and the times and times when the power supplied by the other power supply source 50 excessively exceeds the power needed for the predetermined facility 60. In the parking reservation process shown in FIG. 4, the parking reservation management device 20 determines whether the parking period corresponds to the requested power adjustment period for the predetermined facility 60 in response to the input of the parking reservation form from the users' terminal 220 (step S190). The parking reservation management device 20 performs a confirmation process to confirm that the vehicle is chargeable and dischargeable for use in the VPP and to confirm permission for use in the VPP when it is determined that the parking period corresponds to the requested power adjustment period (step S200), and the parking reservation management device 20 performs the parking reservation process shown in FIG. 3 below in the same manner. On the other hand, when the parking reservation management device 20 determines that the parking period does not match the requested power adjustment period, the user's vehicle is assigned to a parking space other than the chargeable and dischargeable parking space 36 (chargeable parking space 32 or general parking space) without performing the confirmation process that is a process to confirm the vehicle is chargeable and dischargeable for use to the VPP and to confirm permission for use to the VPP (step S230), and the parking reservation management device 20 performs the parking reservation process shown in FIG. 3 below in the same manner. Such a parking reservation process allows vehicles with a parking period that matches the period during which power needs to be exchanged between the parking lot 30 and the predetermined facility 60 to be preferentially assigned to the chargeable and dischargeable parking space 36, thus allowing more appropriate vehicle to be assigned to the chargeable and dischargeable parking space 36.

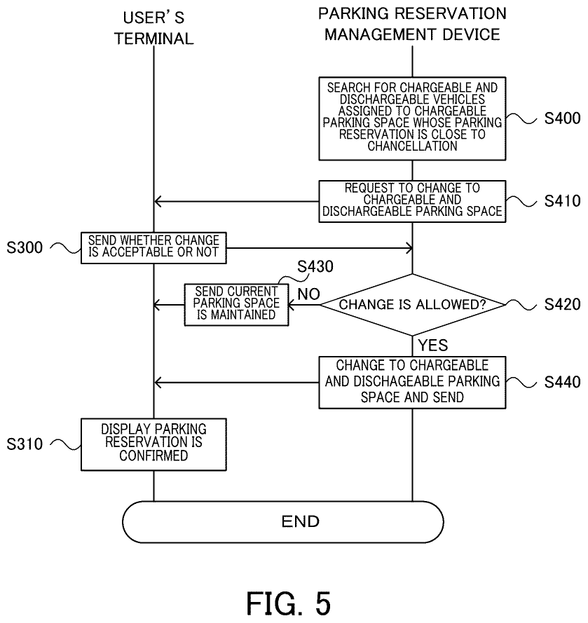

In the parking reservation management device 20 of the embodiment, when a cancellation occurs for a parking reservation in the chargeable and dischargeable parking space 36, a vehicle that can be charged and discharged to the battery installed in the vehicle among the vehicles that have been assigned to parking spaces other than the chargeable and dischargeable parking space 36 may be necessary to encourage changes to parking in the chargeable and dischargeable parking space 36. In this case, the reservation cancellation process illustrated in FIG. 5 may be executed.

In the reservation cancellation process shown in FIG. 5, the parking reservation management device 20 first searches for vehicles assigned to the chargeable parking space 32 whose parking reservation is close to the cancellation slot and whose batteries are chargeable and dischargeable (step S400), and sends a request to the users' terminal 220 of the searched vehicle to change the parking space to the chargeable and dischargeable parking space 36 (step S410). The request is not only confirm whether the change is acceptable or not to the chargeable and dischargeable parking space 36, but also confirm that the vehicle is chargeable and dischargeable for use in the VPP and that it is permitted for use in the VPP. This request can be made by sending a message such as “A change to the chargeable and dischargeable parking space is available. The change requires confirmation that the vehicle is chargeable and dischargeable for use in the VPP and confirmation of permission for use in the VPP.”

In response to such a request, when the users' terminal 220 sends whether the change is acceptable or not to the parking reservation management device 20 (step S300), the parking reservation management device 20 determines whether the change to the chargeable and dischargeable parking space 36 is allowed (step S420). When it is determined that the change to the chargeable and dischargeable parking space 36 has been denied, the parking reservation management device 20 sends a control signal to users' terminal 220 to indicate that the current parking space allocated to the subject user will be maintained (step S430), and the parking reservation management device 20 terminates the reservation cancellation process. The users' terminal 220 that receives the control signal indicating that the current parking space is to be maintained displays information on the current parking reservation (step S310), and the users' terminal 220 terminates the reservation cancellation process.

On the other hand, when it is determined that the change to the chargeable and dischargeable parking space 36 is affirmed in step S420, the parking reservation management device 20 changes the vehicle for the parking reservation to be assigned to the chargeable and dischargeable parking space 36, and sends a control signal to the users' terminal 220 to display the assigned parking space identification number, location in addition to the items entered on the parking reservation form (step S440), and the parking reservation management device 20 terminates the reservation cancellation process. The users' terminal 220 that receives the control signal to display the changed information for the assignment to the chargeable and dischargeable parking space 36 displays the information for the changed parking reservation (step S310), and the users' terminal 220 terminates the reservation cancellation process.

In the parking reservation management device 20 of the embodiment described above, when a cancellation occurs in the reservation of a vehicle allocated to the chargeable and dischargeable parking space 36, the user of a vehicle not allocated to the chargeable and dischargeable parking space 36 is asked to confirm that the vehicle is chargeable and dischargeable for use in the VPP and to confirm that the user is permitted to use the VPP. This allows the cancellation of a reservation for a vehicle assigned to the chargeable and dischargeable parking space 36 to encourage the assignment of another parked vehicle to that canceled slot.

The parking reservation management device 20 in the embodiment assumes the electric vehicle 120 that runs by driving the motor 122 using power from the battery 124 as a vehicle that can use the chargeable and dischargeable parking space 36 in the parking lot 30. However, any vehicle that is equipped with a chargeable and dischargeable battery is acceptable. For example, the vehicle may be a hybrid vehicle with an engine, motor, and battery, or a fuel cell vehicle with a fuel cell and battery, or various other configurations.

The parking reservation system 10 in the embodiment comprises the communication network 12, the parking reservation management device 20, and the users' terminal 220. However, the users' terminal 220 may be an in-vehicle unit consisting of the electronic control unit 130 of the electric vehicle 120, the display unit 150, the communication unit 152, and so on. In this case, the parking reservation form may be pre-populated with information such as the user's name, the user's address, the scheduled date and time of entry into the parking lot, the scheduled date and time of exit from the parking lot, the type of vehicle, and whether the vehicle is chargeable and dischargeable to the battery installed in the vehicle. A computer connected to the web may also be used as the users' terminal 220.

In the parking reservation system 10 of the embodiment, an airport is assumed as the predetermined facility 60. However, the predetermined facility 60 may also be a large leisure facility with a hotel or other facilities, a shopping center, a railroad station, a port, etc.

In the parking reservation management device of the present disclosure, the parking reservation management device may input a scheduled entry date and time and a scheduled exit date and time when making the parking reservation, and may assign the vehicle with the longest parking period obtained based on the scheduled entry date and time and the scheduled exit date and time to the chargeable and dischargeable parking space preferentially. This allows for more effective exchange of power to and from the predetermined facility, and more appropriate vehicle can be assigned to park in the chargeable and dischargeable parking space. In this case, the parking lot may be attached to an airport, and the scheduled entry date and time and scheduled exit date and time may be calculated from a flight schedule based on an input of a flight ticket identification number. Also, the parking reservation management device may perform the confirmation process when the parking period is a period when power exchange with the predetermined facility is required, based on a power supply and demand information obtained from a power management system that manages the power exchange with the predetermined facility, and the parking reservation management device may not perform the confirmation process when the parking period is a period that does not require power exchange with the predetermined facility. In this way, vehicles can be assigned to the chargeable and dischargeable parking space for the parking period that matches the period during which power needs to be exchanged between the parking lot and the predetermined facility, and more appropriate vehicles can be assigned to the chargeable and dischargeable parking space.

In the parking reservation management device of the present disclosure, the parking reservation management device may send a notice to a user of the vehicle that has not been allocated the chargeable and dischargeable parking space that the vehicle can be allocated to the chargeable and dischargeable parking space by performing the confirmation process when a cancellation occurs in the reservation of the vehicle allocated to the chargeable and dischargeable parking space. This way, when a cancellation occurs in the reservation of a vehicle assigned to a chargeable and dischargeable parking space, the parking reservation management device can encourage other parking vehicles to be assigned to the canceled slot.

The following is an explanation of the correspondence between the main elements of the embodiment and the main elements of the disclosure described in the section on means to solve the problem. In the embodiment, the communication network 12 corresponds to “communication network”, the electric vehicle 120 corresponds to “the vehicle”, the battery 124 corresponds to “the battery”, the charging device 34 corresponds to “the charging device”, the chargeable parking space 32 corresponds to “the chargeable parking space”, the charging and discharging device 38 corresponds to “the charging and discharging device”, the chargeable and dischargeable parking space 36 corresponds to “chargeable and dischargeable parking space,” the predetermined facility 60 corresponds to “the predetermined facility,” the parking lot 30 corresponds to “the parking lot,” and the parking reservation management device 20 corresponds to “the parking reservation management device.”

The correspondence between the major elements of the embodiment and the major elements of the disclosure described in the means to solve a problem section is an example of how the embodiment can be used to specifically explain the embodiment of the disclosure described in the means to solve a problem section. This does not limit the elements of the disclosure described in the means to solve the problem section. In other words, interpretation of the disclosure described in the means to solve a problem section should be based on the description in that section, and the embodiment is only one specific example of the disclosure described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure is applicable to the manufacturing industry for the parking reservation management device and other applications.

1. A parking reservation management device for a parking lot that can communicate via a communication network, having a chargeable parking space to which a charging device for charging a battery installed in a vehicle is attached and a chargeable and dischargeable parking space to which a charging and discharging device for charging and discharging the battery is attached, and capable of exchanging electric power between the parking lot and a predetermined facility, the parking reservation management device is characterized by:
the parking reservation management device performs, when making a parking reservation, a confirmation process to confirm that the vehicle to be parked is chargeable and dischargeable of the battery by the charging and discharging device, and to confirm that the charging and discharging device may charge and discharge the battery while the vehicle is parked, and the parking reservation management device assigns a chargeable and dischargeable parking space preferentially to the vehicle that has been confirmed by the confirmation process.

2. The parking reservation management device according to claim 1, wherein the parking reservation management device inputs a scheduled entry date and time and a scheduled exit date and time when making the parking reservation, and assigns the vehicle with the longest parking period obtained based on the scheduled entry date and time and the scheduled exit date and time to the chargeable and dischargeable parking space preferentially.

3. The parking reservation management device according to claim 2, the parking lot is attached to an airport, and the parking reservation management device calculates the scheduled entry date and time and the scheduled exit date and time from a flight schedule based on an input of a flight ticket identification number.

4. The parking reservation management device according to claim 2, wherein the parking reservation management device performs the confirmation process when the parking period is a period when power exchange with the predetermined facility is required, based on a power supply and demand information obtained from a power management system that manages the power exchange with the predetermined facility, and the parking reservation management device does not perform the confirmation process when the parking period is a period that does not require power exchange with the predetermined facility.

5. The parking reservation management device according to claim 1, wherein the parking reservation management device sends a notice to a user of the vehicle that has not been allocated the chargeable and dischargeable parking space that the vehicle can be allocated to the chargeable and dischargeable parking space by performing the confirmation process when a cancellation occurs in the reservation of the vehicle allocated to the chargeable and dischargeable parking space.
